(19) United States
(12) Patent Application Publication
(10) Pub. No.: US 2018/0210183 A1
(43) Pub. Date: Jul. 26, 2018

(54) SLIDE FOR POSITIONING ACCURACY MANAGEMENT AND POSITIONING ACCURACY MANAGEMENT APPARATUS AND METHOD

(71) Applicant: CANON KABUSHIKI KAISHA, Tokyo (JP)

(72) Inventor: Koichiro Nishikawa, Takasaki-shi (JP)

(21) Appl. No.: 15/748,814

(22) PCT Filed: Aug. 4, 2016
(86) PCT No.: PCT/JP2016/003609

§ 371 Date: Jan. 30, 2018

(30) Foreign Application Priority Data
Aug. 28, 2015 (JP) 2015-169726

(51) Int. Cl. G02B 21/34; G02B 21/26; G02B 21/36

(52) U.S. Cl. CPC G02B 21/34; G02B 21/36; G02B 21/26

(57) ABSTRACT

A slide for positioning accuracy management for a stage for a microscope is provided. The slide comprises: a first mark for specifying a position of a slide origin; a plurality of position display areas arranged in matrix and each including a second mark indicating a position and a position coordinate code for specifying coordinates of the position based on the slide origin; and a plurality of third marks arranged in matrix in an area other than the plurality of position display areas at intervals smaller than intervals of the position display areas.

### TECHNICAL FIELD

The present invention relates to a slide for positioning accuracy management and a positioning accuracy management apparatus and method.

### BACKGROUND ART

Recently, the cancer rate tends to greatly increase. When medically treating cancer, it is important to perform pathological diagnosis for differentiating the properties of the cancer. A treatment policy is decided in accordance with diagnosis contents. In such pathological diagnosis, it is necessary to precisely observe the microstructure of a tissue section at microlevel with a microscope. An optical microscope is an especially important tool for pathologists.

For example, a pathologist screens an entire object placed on a slide at a low magnification with a microscope, and stores or records the position of a stage for a microscope at which a region (ROI: Region Of Interest) required to be observed in detail has been observed. After the end of screening at a low magnification, a search is made for the observation position of the ROI based on the stored or recorded position of an X-Y stage, and then the microscope is switched to a high magnification to perform precise screening, diagnosis, or the like. In this case, the reproducibility of the observation position depends on the scale of the stage for the microscope.

In general, an electric stage is provided with a scale such as an encoder. It is therefore important to perform position/distance calibration at the time of observation using a microscope. For such calibration, a test target (test chart) for distance calibration or the like is used. For example, there is available, as microscope test target, for example, a 20× to 100× linear scale of a multi-calibration chart available from Edmund Optics Japan. In addition, Japanese Patent Laid-Open No. 10-506478 discloses a slide glass as a test target.

Even if, however, an output from the encoder is accurately calibrated by using the above test target, when the slide is re-mounted, a parallel position shift and a rotation position shift may occur. The occurrence of such a parallel position shift and rotation shift makes it impossible to accurately access the same ROI position.

The present applicant has proposed a microscope system which can perform position information management at submicron level. In this system, a slide is provided with marks for defining an origin and X- and Y-coordinate axes based on the microscope, and the microscope's side is provided with a stage for a microscope and an imaging mechanism which are used to correct the rotation shift and origin position shift of the slide. According to the proposed microscope system, even if a sample experiences a horizontal position shift and a rotation position shift, it is possible to match the marks provided on the slide to define the origin and the X- and Y-coordinate axes with an absolute coordinate system based on the microscope. This can cancel the position shifts and obtain absolute position reproducibility.

When constructing such a microscope system, however, in order to guarantee the position control performance at submicron level, it is necessary to provide a means for checking the accuracy of the position management performance. From the pathologist's point of view, the position information of an evidence image provided in pathological diagnosis needs to be effective at micron/submicron level and guaranteed in terms of accuracy. For this purpose, the pathologist's side needs to check the accuracy of position management performance as daily routine. In the present circumstances, however, there is no means which can be used for the above purpose and checks the accuracy of position management performance. This may degrade the accuracy of the above position information.

### SUMMARY OF INVENTION

An embodiment of an aspect of the present invention provides a slide for positioning accuracy management which can be used for a microscope system.

According to one aspect of the present invention, there is provided a slide for positioning accuracy management for a stage for a microscope, the slide comprising: a first mark for specifying a position of a slide origin; a plurality of position display areas arranged in matrix and each including a second mark indicating a position and a position coordinate code for specifying coordinates of the position based on the slide origin; and a plurality of third marks arranged in matrix in an area other than the plurality of position display areas at intervals smaller than intervals of the position display areas.

According to another aspect of the present invention, there is provided a positioning accuracy management apparatus comprising: imaging means, mounted on a stage, for obtaining a microscope image of the above-defined slide for positioning accuracy management; detection means for detecting a slide origin of the slide for positioning accuracy management from the microscope image obtained by the imaging means; moving means for moving the stage upon instructing movement amounts in X and Y directions to the stage; obtaining means for obtaining a coordinate value at a specific position in a microscope image obtained by the imaging means after movement of the stage by the moving means based on a position display area and a third mark included in the microscope image; and determination means for determining an error based on an actual movement amount of the stage obtained based on a position of the slide origin detected by the detection means and a coordinate value of the specific position and the instructed movement amount.

According to another aspect of the present invention, there is provided a positioning accuracy management method using the above-defined slide for positioning accuracy management, the method comprising: detecting a slide origin of the slide for positioning accuracy management from a microscope image obtained by obtaining an image from a microscope for the slide for positioning accuracy management which is mounted on a stage; moving the stage upon instructing movement amounts in X and Y directions to the stage; obtaining a coordinate value at a specific position in a microscope image obtained by obtaining an image form the microscope after movement of the stage in the moving based on a position display area and a third mark included in the microscope image; and determining an error based on an actual movement amount of the stage obtained based on a position of the slide origin detected in the detecting and a coordinate value of the specific position and the instructed movement amount.

Further features of the present invention will become apparent from the following description of exemplary embodiments (with reference to the attached drawings).

### BRIEF DESCRIPTION OF DRAWINGS

FIG. 1 is a view showing an outer appearance of a slide for positioning accuracy management according to the first embodiment.

FIG. 2 is a view showing an example of a slide having an origin mark.

FIG. 3 is a view showing the layout of reference marks according to the first embodiment.

FIG. 4 is a dimensional diagram showing the details of reference marks.

FIG. 5 is a view showing an outline of an area for management of positioning accuracy according to the first embodiment.

FIG. 6A is a view for explaining the definitions of position coordinates according to the first embodiment.

FIG. 6B is a view for explaining the definitions of position coordinates according to the first embodiment.

FIG. 7 is a view showing an example of an address area according to the first embodiment.

FIG. 8A is a view showing an example of an address area according to the first embodiment.

FIG. 8B is a view showing an example of an address area according to the first embodiment.

FIG. 8C is a view showing an example of an address area according to the first embodiment.

FIG. 9 is a view showing the layout dimensions of an address area according to the first embodiment.

FIG. 10A is a view for explaining coordinate codes according to the first embodiment.

FIG. 10B is a view for explaining coordinate codes according to the first embodiment.

FIG. 11 is a view showing the arrangement of an absolute position address area according to the first embodiment.

FIG. 12A is a view showing a reticle layout according to the first embodiment.

FIG. 12B is a view showing a reticle layout according to the first embodiment.

FIG. 13 is a schematic view of a microscope system according to the embodiment.

FIG. 14A is a schematic view showing an image at the time of setting an origin and X- and Y-coordinate axes.

FIG. 14B is a schematic view showing an image at the time of setting an origin and X- and Y-coordinate axes.

FIG. 14C is a schematic view showing an image at the time of setting an origin and X- and Y-coordinate axes.

FIG. 14D is a schematic view showing an image at the time of setting an origin and X- and Y-coordinate axes.

FIG. 15A is a schematic view showing an image at the time of reading position coordinates according to the first embodiment.

FIG. 15B is a schematic view showing an image at the time of reading position coordinates according to the first embodiment.

FIG. 15C is a schematic view showing an image at the time of reading position coordinates according to the first embodiment.

FIG. 15D is a schematic view showing an image at the time of reading position coordinates according to the first embodiment.

FIG. 15E is a schematic view showing an image at the time of reading position coordinates according to the first embodiment.

FIG. 16 is a flowchart for checking the address position of a stage arrival point according to the present invention;

FIG. 17A is a view showing the layout of an area for management of positioning accuracy according to the second embodiment.

FIG. 17B is a view showing the layout of an area for management of positioning accuracy according to the second embodiment.

FIG. 18A is an enlarged view showing an intersecting portion of grid lines according to the second embodiment.

FIG. 18B is an enlarged view showing an intersecting portion of grid lines according to the second embodiment.

FIG. 18C is an enlarged view showing an intersecting portion of grid lines according to the second embodiment.

FIG. 18D is an enlarged view showing an intersecting portion of grid lines according to the second embodiment.

FIG. 19A is a view showing the layout of grid lines according to the second embodiment.

FIG. 19B is a view showing the layout of grid lines according to the second embodiment.

FIG. 20A is a view showing an layout near an address area according to the second embodiment.

FIG. 20B is a view showing an layout near an address area according to the second embodiment.

FIG. 21 is a view showing layout dimensions near an address area according to the second embodiment.

### DESCRIPTION OF EMBODIMENTS

A test slide for a microscope system, more specifically, a slide for positioning accuracy management which is used to manage/guarantee the position of a stage for a microscope and the accuracy of a scale according to an example of a preferred embodiment of the present invention will be described below with reference to the accompanying drawings.

### First Embodiment

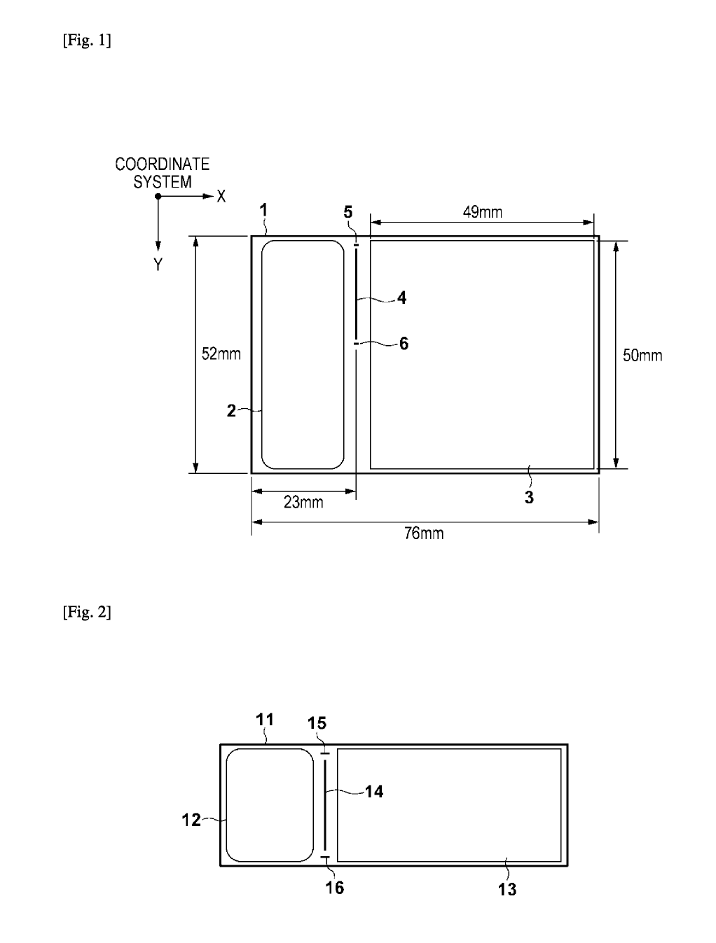

FIG. 1 shows an outer appearance of a slide 1 for positioning accuracy management which is used for positioning accuracy management of a stage for a microscope. According to Japanese Industrial Standards (JIS standard number: JISR3703), the external shapes (lengths×widths) of slide glasses for microscopes include the following: standard type: 76×26 [mm]; large type: 76×52 [mm]; and polarization type: 48×28 [mm] or 45×26 [mm]. This embodiment aims at providing a slide for positioning accuracy management for checking the position arrangement performance of a stage for a microscope which is a stage capable of moving in X and Y directions. A large slice glass is the largest glass which can be held by a microscope slide holder and on which a sample is placed. Therefore, in this embodiment, the outer shape size of the slide 1 is 76×52 [mm], which is the same as the size of a large slide glass for a microscope. It is needless to say that the dimensions of the above-described slide are merely an example, and not limited to above dimensions.

Quartz, which has a small thermal expansion coefficient, is used as a material for the slide 1. The slide has a thickness of about 1 mm. The inside area of the slide includes a label area 2 corresponding to the frost area of a standard slide. A positioning accuracy management area 3 is arranged in the cover glass area of the standard slide on which a sample and a cover glass are placed. First marks for specifying the Y-axis direction of the slide 1 and its origin position are arranged in the sandwiched area between the label area 2 and the positioning accuracy management area 3 (cover glass area) arrayed in the X direction (slide X-axis direction). In this embodiment, as the first marks, reference marks including a Y-axis mark 4, an origin mark 5, and auxiliary origin mark 6 are arranged. The Y-axis mark 4 indicates the direction of a slide Y-axis. The origin mark 5 indicates the direction of a slide X-axis and includes an origin position (slide origin) of the slide. The auxiliary origin mark 6 is used as an auxiliary mark when the origin mark 5 cannot be used because of stain or the like. With regard to the reference marks, the barycentric position of the Y-axis mark 4 in the X direction specifies the X-coordinate of the slide origin, and the barycentric position of the origin mark 5 in the Y direction specifies the Y-coordinate of the slide origin. The Y-axis mark 4, the origin mark 5, and the auxiliary origin mark 6 are arranged at a position spaced away from the left end of the slide 1 by 23 mm and at the upper end of the slide 1. In addition, the origin mark 5 and the auxiliary origin mark 6 are laid out to be perpendicular to the Y-axis mark 4. These marks are formed from light shielding films. According to the standards, since a one-end frost extends 22 mm from the left end at maximum, the marks are set at a position of 23 mm away from the left end.

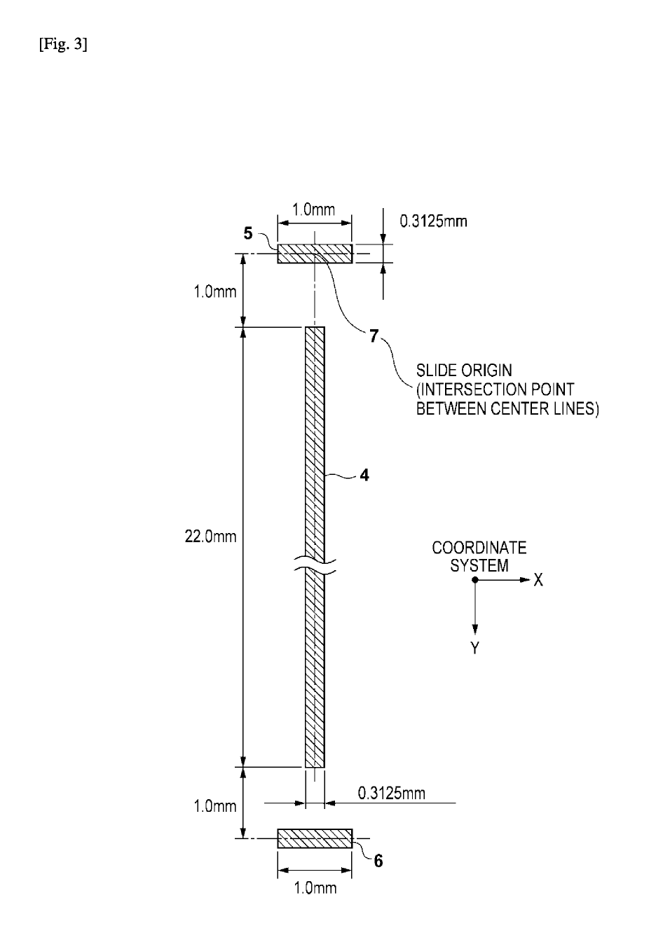

As described above, in a microscope system capable of positioning accuracy management at submicron level, a slide is provided with marks for defining an origin and X- and Y-coordinate axes based on the microscope. The microscope system's side is provided with a stage for a microscope capable of correcting a rotation shift of the slide and an origin position shift and an imaging mechanism. FIG. 2 is a view showing a slide 11 having a standard outer shape which is used for such a microscope system. The slide 11 includes a label area 12 and a cover glass area 13 on which a sample and a cover glass are placed and whose intermediate area is provided with a Y-axis mark 14, an origin mark 15, and an auxiliary origin mark 16. This arrangement of reference marks is suitable for a case in which an available place exists only in the sandwiched area between the label area 12 and the cover glass area 13. Therefore, the positions at which the Y-axis mark 4, the origin mark 5, and the auxiliary origin mark 6 of the slide 1 (FIG. 1) are arranged to match those at which the Y-axis mark 14, the origin mark 15, and auxiliary origin mark 16 of the slide 11 (FIG. 2) are arranged.

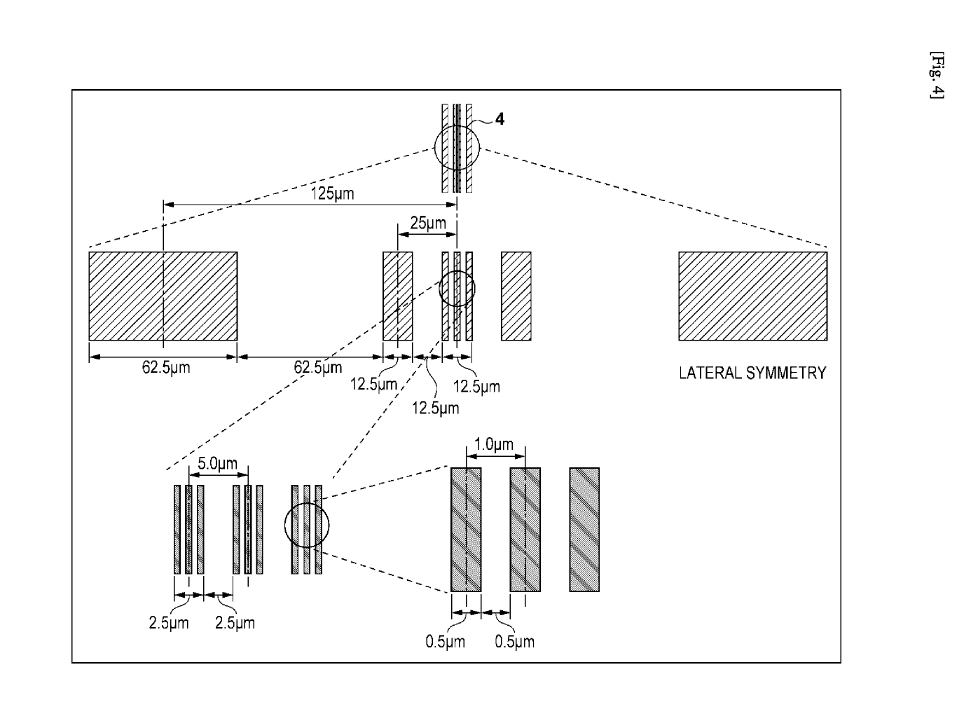

The origin of the slide will be described next. As shown in FIG. 3, the center line of the Y-axis mark 4 indicates the origin of the slide in the X-axis direction, and the center line of the origin mark 5 indicates the origin of the slide in the Y-axis direction. The intersection point between the center line of the origin mark 5 and the center line of the Y-axis mark 4 is the origin of the slide. Note that in the following description, this intersection point will be referred to as a slide origin 7 and is the position origin of the slide 1. The slide origin 7 is observed with a microscope objective lens, and is finally observed and positioned with a high-magnification, high-resolution objective lens such as a 40×/0.95 objective lens. For this reason, the densest pattern of each mark is laid out into a fine structure on the order of visible light wavelengths.

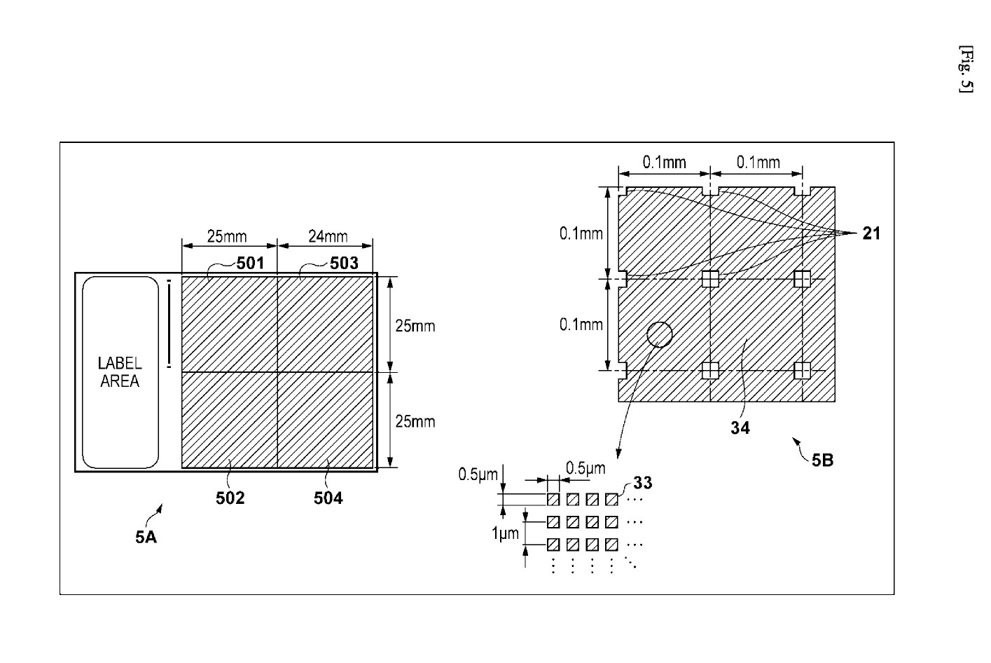

FIG. 4 shows the layout of the Y-axis mark 4 in the widthwise direction. The origin mark 5 and the auxiliary origin mark 6 have similar layouts in the widthwise direction. As shown in FIG. 3, the mark is seen by the naked eye or the like as a line having a width of about 0.3 mm. Each gray portion (hatched portion) represents a light shielding film. The layout structures of the lines in the widthwise direction are laterally symmetrical on the drawing. Therefore, the dimensions shown are those of the left one side of the layout.

As shown in FIG. 4, on the upper part of the drawing, the 0.3125 mm wide line includes, from the left, the 62.5 μm wide line, 62.5 μm wide space, 12.5 μm wide line, 12.5 μm space, 12.5 μm wide line portion (middle portion), 12.5 μm wide space, 12.5 μm wide line, 62.5 μm wide space, and 62.5 μm wide line. The 12.5 μm wide line portion located in the middle includes the 2.5 μm wide line portion, 2.5 μm space, 2.5 μm wide line portion, 2.5 μm space, and 2.5 μm wide line, as enlarged and shown on the lower left. In addition, these 2.5 μm wide line portions each include the three 0.5 μm wide lines and the two 0.5 μm spaces between them, as shown on the right side. Each 0.5 μm wide line corresponding to a fine structure on the order of visible light wavelengths corresponds to the minimum line width of the Y-axis mark 4 (origin mark 5) according to this embodiment. This middle portion constituted by the 0.5 μm wide lines and spaces is useful in accurately deciding a central position when performing observation/measurement with a high-magnification, high-resolution objective lens such as a 20×/0.80 or 40×/0.95 objective lens. In addition, although not explicitly shown, in order to facilitate the formation of a reticle, in this embodiment, the 12.5 μm wide lines and the 62.5 μm wide lines each are laid out with 0.5 μm wide lines and 0.5 μm wide spaces.

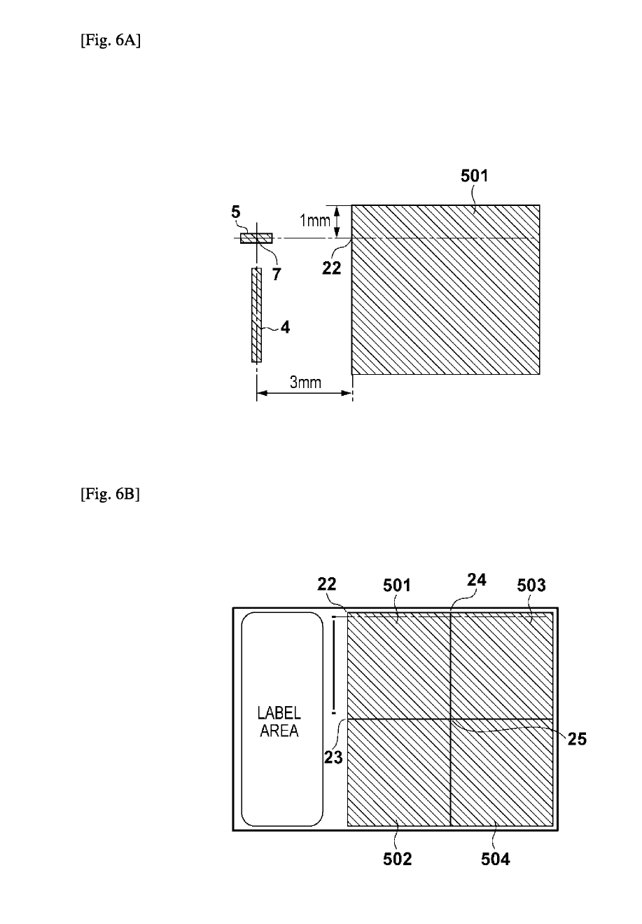

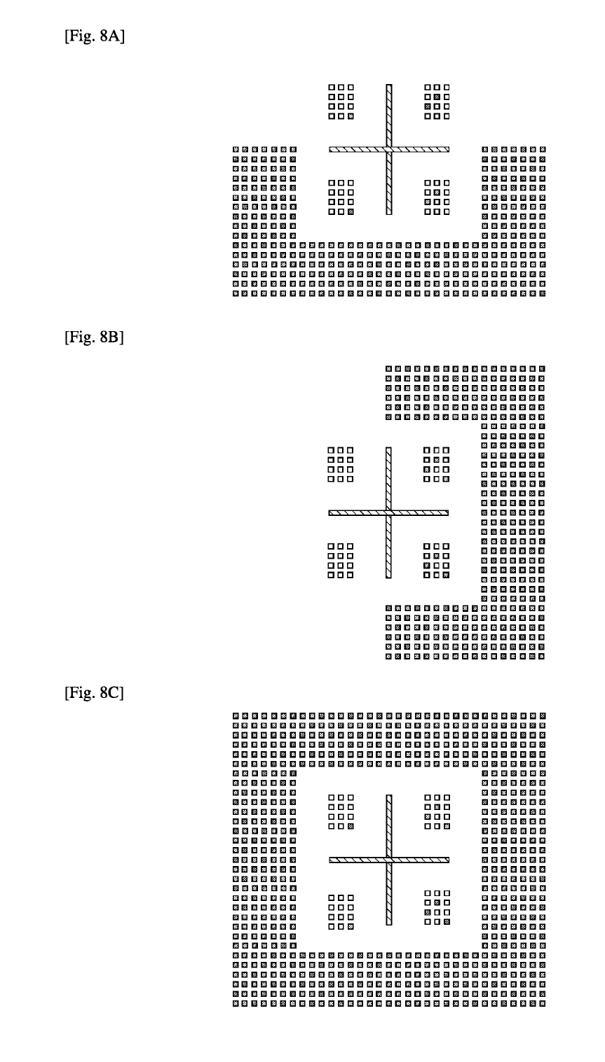

The layout structure of the positioning accuracy management area 3 will be described next. The positioning accuracy management area 3 is an area where address areas 21 and increment marks 33, which are used for positioning accuracy management, are arranged, and which is arranged in the cover glass area. As will be described later with reference to FIG. 7, a second mark for indicating a specific position in the address area and position information concerning the position specified by the second mark are recorded in the address area 21. In this embodiment, as shown in “5A” in FIG. 5, the positioning accuracy management area 3 is divided into four partial areas including a first area 501 to a fourth area 504. The first area 501 has a size of 25 mm×25 mm, the second area 502 has a size of 25 mm×25 mm, the third area 503 has a size of 24 mm×25 mm, and the fourth area 504 has a size of 24 mm×25 mm. In each divided area, the address areas 21, each (having a size of 20 μm×20 μm) serving as a position display area having information for specifying position coordinates based on the slide origin 7, are arranged in matrix at 0.1 mm intervals (100 μm intervals) in both the X and Y directions. Note that the address areas 21 may be arranged at different intervals in the X and Y directions. That is, the address areas 21 are arranged at first predetermined intervals in the X direction, and arranged at second predetermined intervals in the Y direction. The first and second predetermined intervals may be equal or not. In FIG. 5, “5B” is an enlarged view of the upper left end portion of the first area 501, in which each address area 21 is represented by a white area. In addition, in “5B” in FIG. 5, an area other than the address areas 21 (an area other than the position display areas) in the first area 501 is provided with an increment mark area 34 where the increment marks 33 which are minute marks, each serving as a third mark and having a size of 0.5 μm×0.5 μm, are arranged at a pitch of 1.0 μm.

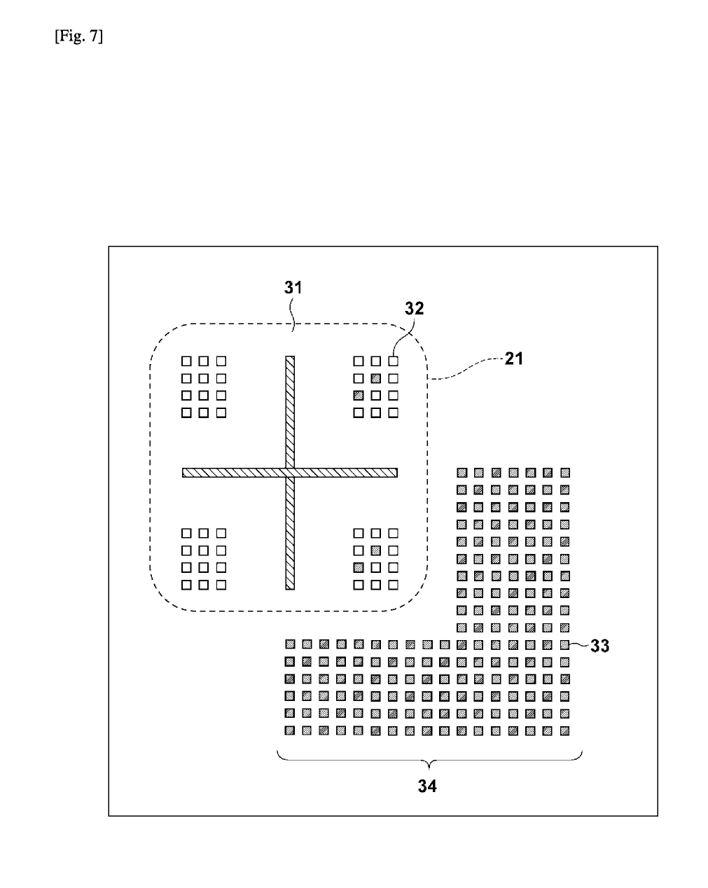

Coordinates on the slide 1 according to this embodiment will be described next with reference to FIGS. 6A and 6B. FIG. 6A shows the positional relationship between the origin mark 5 and a portion near the upper left end of the first area 501. As shown in FIG. 6A, the first area 501 protrudes upward on the drawing from a position based on the slide origin 7 by 1 mm in the Y direction. In addition, the left end of the first area 501 is spaced apart from the slide origin 7 by 3 mm in the X direction. Therefore, the existence range of the address areas 21 in the first area 501 is defined, from the dimension values of the first area 501 shown in FIG. 5, as follow, in increments of 0.1 mm based on the slide origin 7:

X: 3.0 to 27.9, Y: −1.0 to 23.9

In this case, the boundaries among the first area 501, the second area 502, and the third area 503 respectively belong to the second area 502 and the third area 503.

Likewise, the second area 502 is defined by

X: 3.0 to 27.9, Y: 24.0 to 49.0

The third area 503 is defined by

X: 28.0 to 52.0, Y: −1.0 to 23.9

The fourth area 504 is defined by

X: 28.0 to 52.0, Y: 24.0 to 49.0

Note that the boundaries among the second area 502, the third area 503, and the fourth area 504 belong to the fourth area 504. In addition, the Y values from −1.0 to −0.1 of the first and third areas 501 and 503 are made to correspond to the values from 24.0 to 24.9 following the values of the first and third areas 501 and 503 described above. This facilitates the coding of position coordinates described later.

FIG. 6B shows the reference points (origins) of the first to fourth areas 501 to 504. Points 22, 23, 24, and 25 are the origins of the first to fourth areas 501 to 504. The X positions of the origins are the left ends of the first to fourth areas 501 to 504. The Y positions of the origins of the first and third areas 501 and 503 are positions spaced apart from the upper ends flush with the slide origin 7 by 1 mm. The Y positions of the origins of the second and fourth areas 502 and 504 are the upper ends of the respective areas.

When the reference points of the respective areas are set as origins, the position coordinates of the respective areas described above are expressed as follows:

with regard to the first area 501,

X: 0.0 to 24.9, Y: 0.0 to 24.9

with regard to the second area 502,

X: 0.0 to 24.9, Y: 0.0 to 25.0

with regard to the third area 503,

X: 0.0 to 24.0, Y: 0.0 to 24.9

with regard to the fourth area 504,

X: 0.0 to 24.0, Y: 0.0 to 25.0

These coordinates are called relative position coordinates.

Based on the above description, assuming that the origins of the respective areas are expressed by absolute position coordinates based on the slide origin, and the remaining position coordinates are expressed by relative position coordinates, the position coordinates of the respective areas are summarized as follows:

with regard to first area 501,

origin absolute coordinates: (3.0, 0.0)

relative coordinates: X-coordinate=0.0 to 24.9, Y-coordinates=0.0 to 24.9, excluding (0.0, 0.0)

with regard to the second area 502

origin absolute coordinates: (3.0, 24.0)

relative coordinates: X-coordinate=0.0 to 24.9, Y-coordinates=0.0 to 24.9, excluding (0.0, 0.0)

with regard to the third area 503,

origin absolute coordinates: (28.0, 0.0)

relative coordinates: X-coordinate=0.0 to 23.9, Y-coordinates=0.0 to 24.9, excluding (0.0, 0.0)

with regard to the fourth area 504,

origin absolute coordinates: (28.0, 24.0)

relative coordinates: X-coordinate=0.0 to 23.9, Y-coordinates=0.0 to 24.9, excluding (0.0, 0.0)

As described above, the area is divided, and the respective areas are provided with origins associated with the slide origin 7. Therefore, when returning to an origin after accessing a predetermined position, the observation position may return to the origin having absolute coordinates of each area without returning to the origin mark 5 of the slide. This can be expected to provide an advantage of shortening the access time.

The above arrangement will be described in further detail below with reference to FIG. 7. FIG. 7 is an enlarged view near the origin of the first area 501 in FIGS. 6A and 6B, that is, the point 22. As shown in FIG. 7, the address area 21 and the increment mark area 34 constituted by the plurality of increment marks 33 are arranged near the point 22. The address area 21 includes a position mark 31 indicating a position by the intersection point of cross lines and position coordinate codes 32 as position information for specifying coordinates based on the slide origin at the position. Note that FIG. 7 shows part of the increment mark area 34. Referring to FIG. 7, each gray (hatched) portion is a portion having a light shielding film. For the sake of descriptive convenience, each position coordinate code 32 having no light shielding film is indicated by an outlined rectangle. Of the address areas 21 arranged in the respective partial areas, the position coordinate codes 32 in each address area 21 where the position mark 31 is located at the above origin position indicate coordinates (absolute position coordinates) based on the slide origin 7. In addition, position coordinate codes in each address area, of the plurality of address areas 21 arranged in the respective partial areas, in which the position mark 31 indicates a position other than the origin position indicate coordinates (relative position coordinates) based on the origin position of the partial area to which the address area 21 belongs.

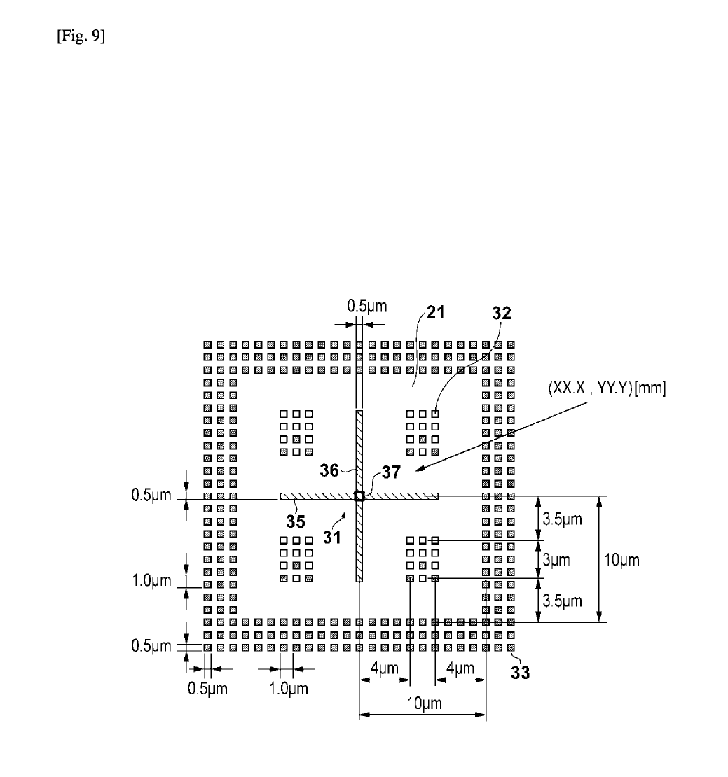

FIGS. 8A to 8C are enlarged views each showing the address area 21 including the position mark 31 and the position coordinate codes 32. FIGS. 8A to 8C are views each showing the characteristic layout of the address area 21 in the first area 501. FIG. 8A exemplarily shows a portion near an address area with coordinates (0.1, 24.0). FIG. 8B exemplarily shows a portion near an address area with coordinates (0.0, 24.1). FIG. 8C exemplarily shows a portion near an address area with coordinates (0.1, 24.1).

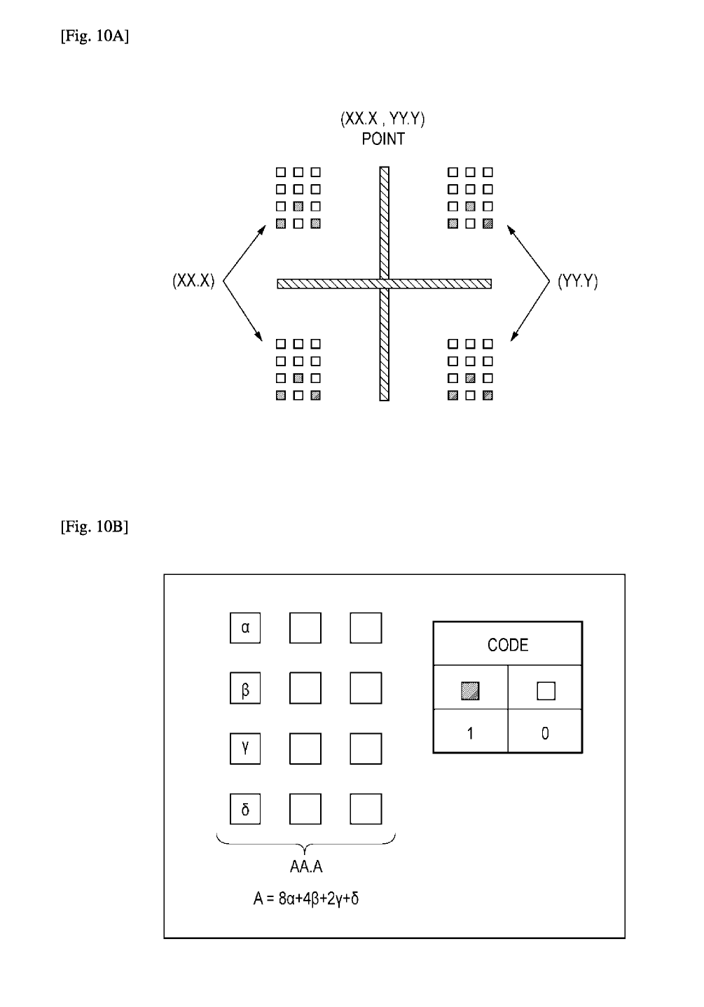

The address area 21 will be described in detail below. FIG. 9 shows the dimensional layout of the address area 21. The position mark 31 comprises a 12-μm long X-direction line 35 having a width of 0.5 μm and a 13-μm long Y-direction line 36 that are crossing with each other. The intersection point between the X-direction line 35 and the Y-direction line 36 (to be referred to as a position mark intersection point 37 hereinafter) indicates an absolute position coordinates or relative position coordinates (XX.X, YY.Y) [mm].

Predetermined spaces are provided between the position mark 31, the position coordinate codes 32, and the increment mark area 34. The shortest distances between the position mark intersection point 37 and the increment mark 33 are 10 μm in both the X and Y directions. The shortest distances between the position mark 31 and the position coordinate code 32 are respectively 4 μm and 3.5 μm in the X and Y directions. The shortest distances between the position coordinate code 32 and the increment mark 33 are respectively 4 μm and 3.5 μm in the X and Y directions. This suppresses the occurrence of an error when obtaining and processing an image. The increment marks 33, each having a square shape and a size of 0.5 μm×0.5 μm, are arranged at a pitch of 1.0 μm.

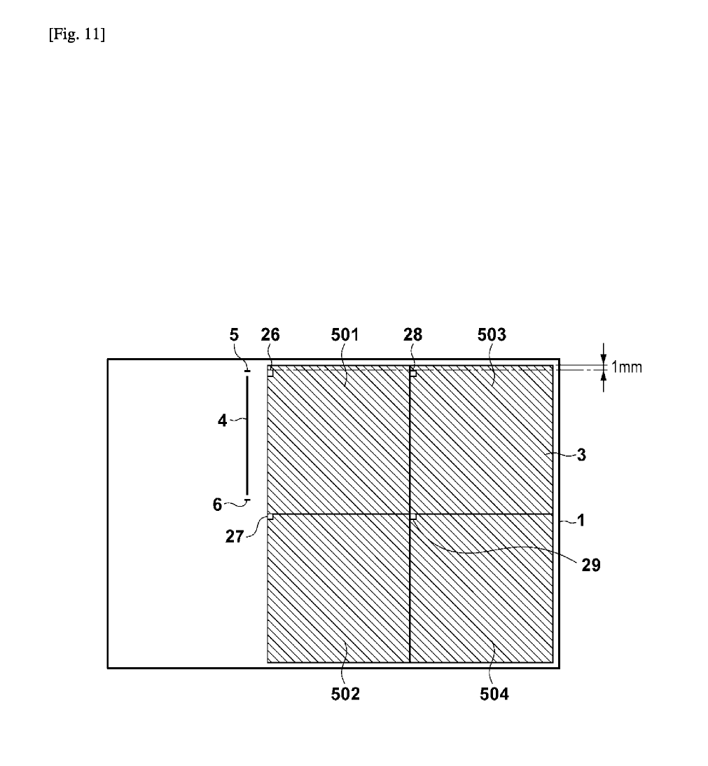

The position coordinate code 32 will be described next. As shown in FIG. 10A, codes, each representing the X-coordinate of (XX.X, YY.Y) [mm], are arranged on both sides of the X-direction line 35 on the left side of the Y-direction line 36. These codes are identical codes and represent the same X-coordinate value. Likewise, codes each representing the Y-coordinate are arranged on both sides of the X-direction line 35 on the right side of the Y-direction line 36. These codes are identical codes and represent the same Y-coordinate value. In order to improve the resistance to stain, flaw, and the like, two or more sets of patterns representing the same coordinate value are arranged as the position coordinate codes 32. In this embodiment, two sets of patterns representing a coordinate value are arranged. However, three or more sets of patterns may be arranged.

In addition, as shown in FIG. 10B, numerical values of the respective digits (tens digit, ones digit, and tenths digit in mm notation) of codes representing a position, that is, the X-coordinate value XX.X and the Y-coordinate value YY.Y, are arranged as αβγδ in binary notation along the Y-axis. Assuming that each black rectangle (with a mark) represents 1, each white rectangle (without any mark) represents 0, and A represents a numerical value, then

A=8α+4β+2γ+δ

The arrangements of the above marks and codes are not limited to those described above. For example, the X-coordinate value and the Y-coordinate value may be interchanged. In addition, the codes representing the X-coordinate value and the code representing the Y-coordinate value may be respectively arranged across the position mark intersection point 37. Furthermore, the sequences of αβγδ may be arranged in mirror symmetry with respect to the X-direction line 35, the Y-direction line 36, or the position mark intersection point 37. Note that in this embodiment, the marks representing the codes each have the same size as that of the increment mark 33, and are arranged at the same intervals (regarding each white rectangle as identical). However, arrangements of such marks are not limited to this. In addition, codes representing a position are not limited to those in this embodiment. For example, QR codes® or the like may be used, or micro characters may be used instead of codes.

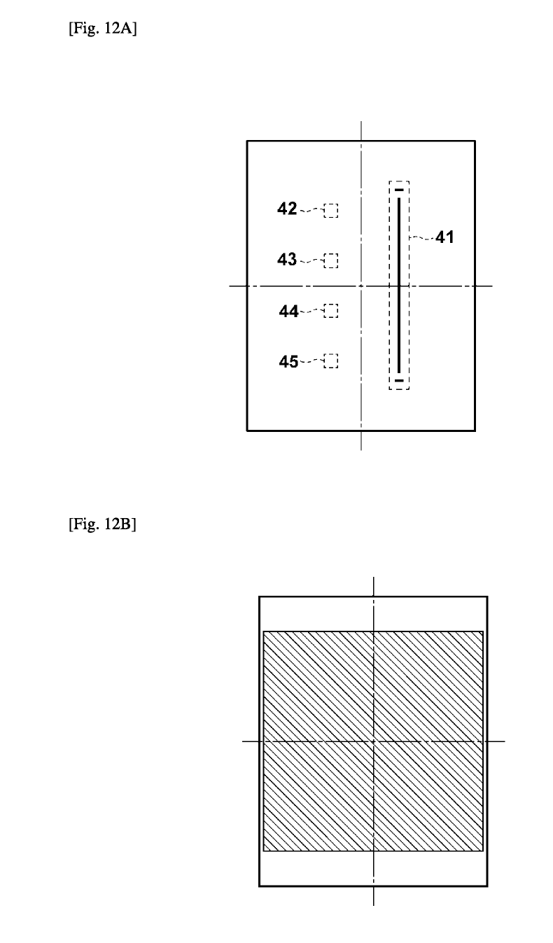

A method of manufacturing the slide 1 will be described next. A pattern arranged on the slide 1 is formed by projecting and exposing reticle patterns using a reduced projection exposure apparatus. FIG. 11 is a view for explaining a pattern formed on the slide 1 by projection exposure. The pattern formed by projection exposure includes the Y-axis mark 4, the origin mark 5, the auxiliary origin mark 6, and the first to fourth areas 501 to 504 (including the address areas 21 and the increment mark areas 34). Note that of the address areas 21 in each area, the address area located at the origin position is an absolute position address area. FIG. 11 shows an absolute position address area 26 in the first area 501, an absolute position address area 27 in the second area 502, an absolute position address area 28 in the third area 503, and an absolute position address area 29 in the fourth area 504.

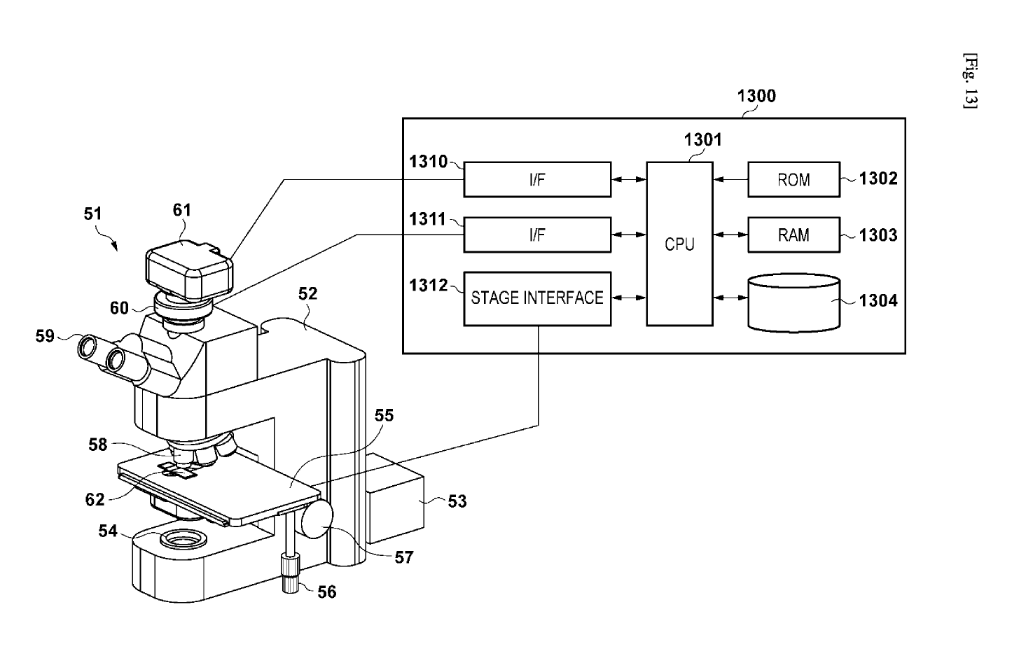

FIGS. 12A and 12B show reticles serving as masks. FIG. 12A shows a reticle corresponding to the Y-axis mark 4, the origin mark 5, the auxiliary origin mark 6, and the absolute position address areas 26 to 29 in the four divided areas in FIG. 11. A reticle area 41 is provided in correspondence with the Y-axis mark 4, the origin mark 5, and the auxiliary origin mark 6. Reticle areas 42 to 45 are respectively provided in correspondence with the absolute position address areas 26 to 29. FIG. 12B shows a reticle formed from a pattern which is common to the first to fourth areas 501 to 504 and corresponds to the areas other than the absolute position address area (the relative position address areas and the increment mark area between the address areas).

The reduced projection exposure apparatus projects and exposures a reticle pattern upon reducing it to ¼ to ⅕ by using a projection lens. This embodiment uses ¼ reduced exposure. Therefore, the reticle pattern serving as a mask is four times larger than the pattern shown in FIG. 11. The pattern shown in FIG. 11 is formed by performing multiple exposure sequentially using the reticles in FIGS. 12A and 12B. The 1 mm wide upper end area of the first and second areas 501 and 503 is exposed by using the lower end portion of the reticle in FIG. 12B. As a consequence, the reticles required to form the pattern on the slide 1 according to this embodiment are the two reticles shown in FIGS. 12A and 12B.

Consider a case in which all the address areas in the positioning accuracy management area 3 are absolute position coordinates or a case in which one given point in the positioning accuracy management area 3 is regarded as an origin assigned as absolute position coordinates, and other points are regarded as relative position coordinates based on the origin. In this case, required reticles include one reticle corresponding to the Y-axis mark 4, the origin mark 5, and the auxiliary origin mark 6, and a reticle corresponding to the positioning accuracy management area 3. However, a general reticle size is about 132 mm×132 mm, and the positioning accuracy management area 3 according to this embodiment has a size of 49 mm×50 mm. Assuming that reduced exposure with reduction to ¼ is performed, at least a reticle size of about 196 mm×200 mm is required, and at least four reticles are required for the positioning accuracy management area 3. As a consequence, a total of at least five reticles are required. In general, a reticle is patterned by using an expensive electron beam exposure apparatus, and hence the number of reticles to be used influences a manufacturing cost.

According to the first embodiment, as described above, since the number of reticles to be used can be reduced from five to two, it is possible to suppress a manufacturing cost. This is one of the reasons why the positioning accuracy management area 3 is divided into four areas, and is the second advantage in addition to the above advantage of “shorting the access time”

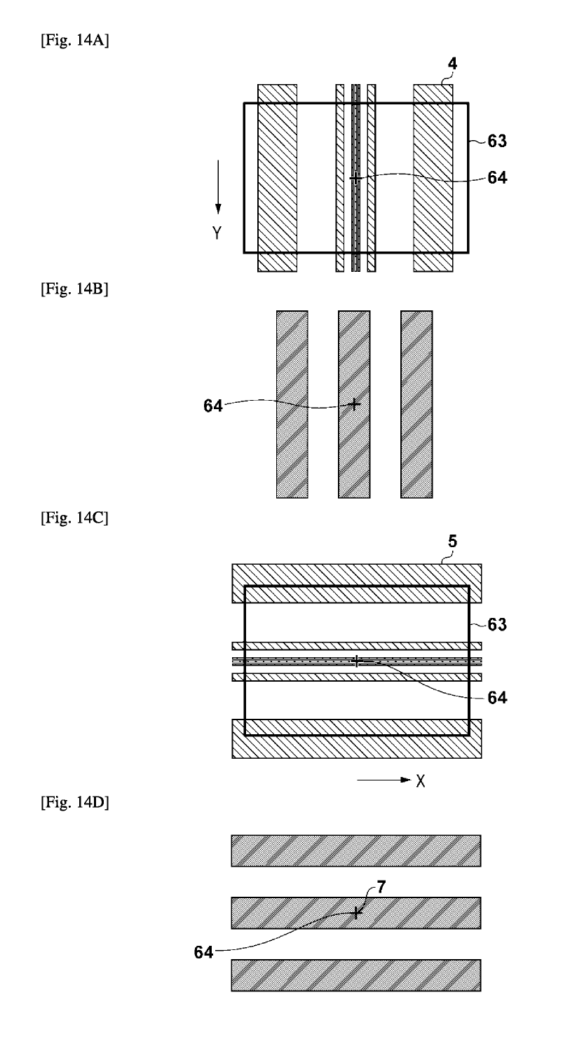

A method of using and a method of operating the slide 1 according to this embodiment will be described next. FIG. 13 schematically shows a microscope system capable of position information management according to this embodiment.

A microscope system 51 is a transmission microscope having the following components mounted on a mirror base 52: an illumination light source 53, an illumination optical system 54, an XYZ stage 55, an objective lens 58, an eyepiece lens 59, an optical adapter 60, and the like. An image from the objective lens 58 is guided to the eyepiece lens 59 for magnified observation and observed by the user. In addition, the optical adapter 60 magnifies an image from the objective lens 58, which does not propagates to the eyepiece lens 59, and forms the image on the sensor of a digital camera 61.

The XYZ stage 55 moves a slide 62 placed on it in the X, Y, and Z directions in an electric mode using an internal scale (encoder) and a manual mode using an XY knob 56 and a Z knob 57. The origin and X- and Y-axes of the XYZ stage 55 are set to strictly match the central position and pixel array of the sensor of the digital camera 61 based on the optical axis of the objective lens 58. The moving direction of the XYZ stage 55 is adjusted to move along the X- and Y-axes. In addition, the XYZ stage 55 has, on it, a mechanism (not explicitly shown) capable of adjusting the rotation of the slide 62. For example, when the slide 62 has an origin and an X-axis or Y-axis like the slide 11 exemplarily shown in FIG. 2, the origin and the X- and Y-axes are strictly adjusted to the origin and coordinate axes of the microscope system 51.

In this embodiment, the optical adapter 60 incorporates a lens which increases the imaging magnification by 2.5 times the object lens magnification. When the sensor of the digital camera 61 has a full size of 24 mm×36 mm, the diameter of the visual field in which the imaging performance of the microscope remains good is about 18 mm or less, it is common to use a lens which increases the magnification by 2.5 times to cover the imaging performance of the sensor of the digital camera 61 with a margin. In addition, the optical adapter 60 includes a camera rotating mechanism for matching the X- and Y-axes with the pixel array based on the mirror base 52.

A positioning accuracy management procedure in the microscope system 51 described above when the XYZ stage 55 operates in the electric mode will be described below. The microscope system 51 is connected to an information processing apparatus 1300 such as a PC (Personal Computer) and operates under the control of the information processing apparatus 1300. In the information processing apparatus 1300, a CPU 1301 controls the operation of the microscope system 51 by executing programs stored in a ROM 1302. The ROM 1302 is a read only memory and stores various types of programs executed by the CPU 1301. A RAM 1303 is a readable/writable memory and operates as a work memory for the CPU 1301. A secondary storage device 1304 is a large-capacity storage medium such as a hard disk.

A camera interface 1310 communicably connects the information processing apparatus 1300 to the digital camera 61. An adapter interface 1311 connects the optical adapter 60 to the information processing apparatus 1300 to allow the CPU 1301 to implement control of the optical adapter 60. A stage interface 1312 connects the XYZ stage 55 to the information processing apparatus 1300 to allow the CPU 1301 to implement driving of the XYZ stage 55. Each interface can be implemented by, for example, a USB. The following description is based on the assumption that the pixel array of the sensor of the digital camera 61 is matched with the X- and Y-axes based on the mirror base 52.

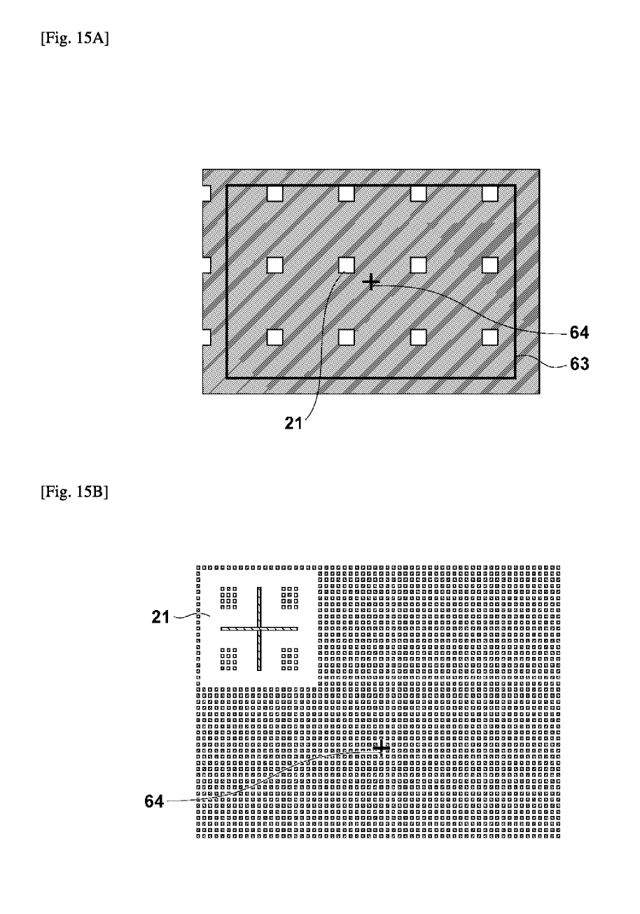

First of all, the slide 1 is placed instead of the slide 62. The Y-axis mark 4 is aligned with the Y direction (the Y-direction array of pixels) of a sensor 63 of the digital camera 61, as shown in FIG. 14A, by using the rotation adjustment mechanism described above. Thereafter, the central position of the Y-axis mark 4 is aligned with a center 64 (virtually indicated by a cross mark) of the sensor 63 by x-direction translation position control of the XYZ stage 55. FIG. 14A shows how a 40× objective lens and a 2.5× adapter lens are used. FIG. 14B is a schematic view showing a case in which the image in FIG. 14A is magnified by 10 times. The apparent mark width is 0.5 μm. The pixel size of the recent full size sensor is about 7 μm. A mark is magnified by 40 times by the object lens and by 2.5 times by the adapter lens, that is, by 100 times in total, and hence the width “0.5 μm” increases to 50 μm on the sensor 63. About seven sensor pixels correspond to a 0.5 μm wide mark in FIG. 14B in the widthwise direction. In this manner, a barycentric position in the X direction is obtained from the information of each pixel of the image in FIG. 14B with an error accuracy of 0.07 μm or less. This makes it possible to match the central position of the Y-axis mark 4 in the X direction with the center 64 of the sensor 63.

The XYZ stage 55 is then driven to move to the origin mark 5 so as to set the barycentric position of the center mark to a center 64 of the sensor 63 under the Y-direction translation position control. FIG. 14C shows the relationship between the origin mark 5 and the sensor 63. FIG. 14D is an enlarged view which is further magnified by 10 times by digital zooming. In this manner, the origin mark 5 of the slide 1 and the center of the Y-axis mark 4 are decided, and the read coordinates of the XYZ stage 55 (the position coordinate value calculated from an encoder output) are set to an origin (0, 0) of the slide 1. As a result, the origin of the X- and Y-axes of the microscope system 51 is matched with the origin position of the slide 1.

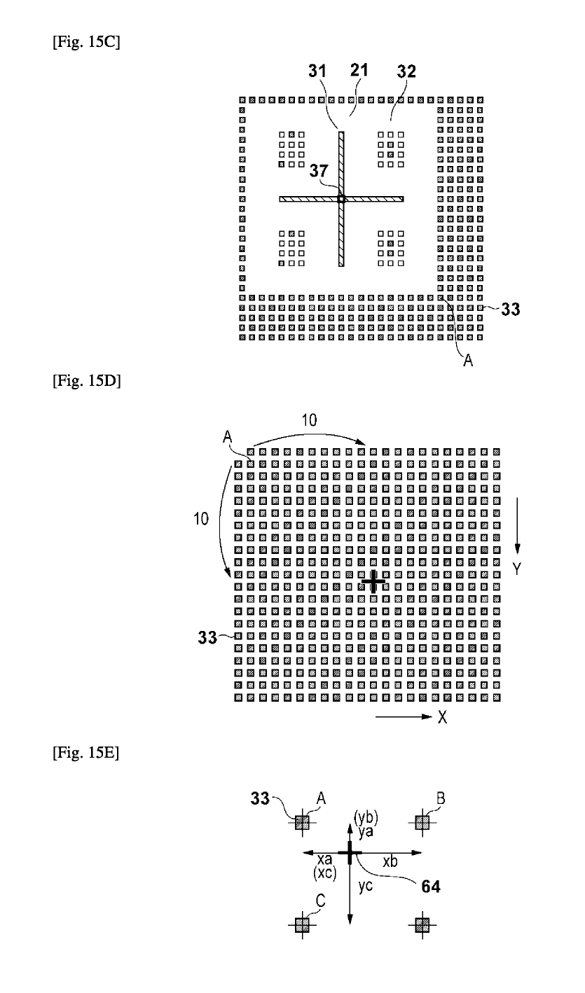

A case in which the XYZ stage 55 is moved to a designated movement destination address will be described next. When the XYZ stage 55 is moved under position control, an image like that shown in FIG. 15A is obtained from the digital camera 61. An image obtained by enlarging a portion near the center 64 of the sensor 63 is seen as shown in FIG. 15B to allow an address area to be checked. When the address area 21 (the position mark 31 and the position coordinate codes 32) nearest to the center 64 of the sensor 63 is enlarged by digital zooming and seen, it looks like that shown in FIG. 15C. FIG. 15D shows a portion near the center 64 of the sensor 63. A pattern can be decomposed and observed even with a 20×/0.80 objective lens, as shown in FIGS. 15A to 15E.

First of all, the position coordinate code 32 in the address area 21 shown in FIG. 15C is read. As a result, in this case, (18.0, 06.0) is read. For example, a designated movement destination address corresponds to the fourth area 504 in the positioning accuracy management area 3 (the absolute position address of the origin is (28.0, 25.0)). In this case, a combination with the relative position (18.0, 06.0) obtained from the address area 21 in FIG. 15C indicates that the center 64 is located near the absolute position (46.0, 31.0).

Furthermore, the columns of the increment marks 33 are counted in the X direction, and the rows of the increment marks 33 are counted in the Y direction, starting from the position mark intersection point 37. Since the distances to the shortest-distance increment mark (point A) shown in FIG. 15C are 10 μm in both the X and Y directions, as described with reference to FIG. 9, the count values are 10 in both the X and Y directions. In this case, as shown in FIG. 15D, the count values from point A to the center 64 of the sensor 63 are 10 in both the X and Y directions. Therefore, the total count values are 20 in both the X and Y directions, which are converted into the X- and Y-coordinates (0.02, 0.02). As a result, the position of the XYZ stage 55 becomes the absolute position (46.02, 31.02) upon addition with the above position (46.0, 31.0). That is, the XYZ stage 55 is controlled to this position. If the center 64 of the sensor 63 is located between increment marks, the position of the center is calculated by interpolation. This makes it possible to check the position on the nm order.

In an early stage of the construction of the microscope system, there may be an error in a coordinate read value relative to a designated position depending on the performance of an encoder (not shown) incorporated in the XYZ stage 55. In this case, the relationship between movement distances (encoder read values) and error values obtained by the above position checking using the slide 1 may be held in a memory (not shown) to correct the movement amount of the XYZ stage 55.

On the user's side, for example, the pathologist's side, when starting work, it is possible to use the above position checking for checking the accuracy of the position management performance of the XYZ stage 55. For example, the user conducts tests at a predetermined position a plurality of times, and considers that there is no problem in position control of the microscope system, if the test result is less than a predetermined error, for example, ±0.5 μm. In addition, since the pitch of the increment marks 33 is strictly 1 μm, it is possible to use the pitch for the calibration of a size at the use of a new system or after the objective lens 58 is changed.

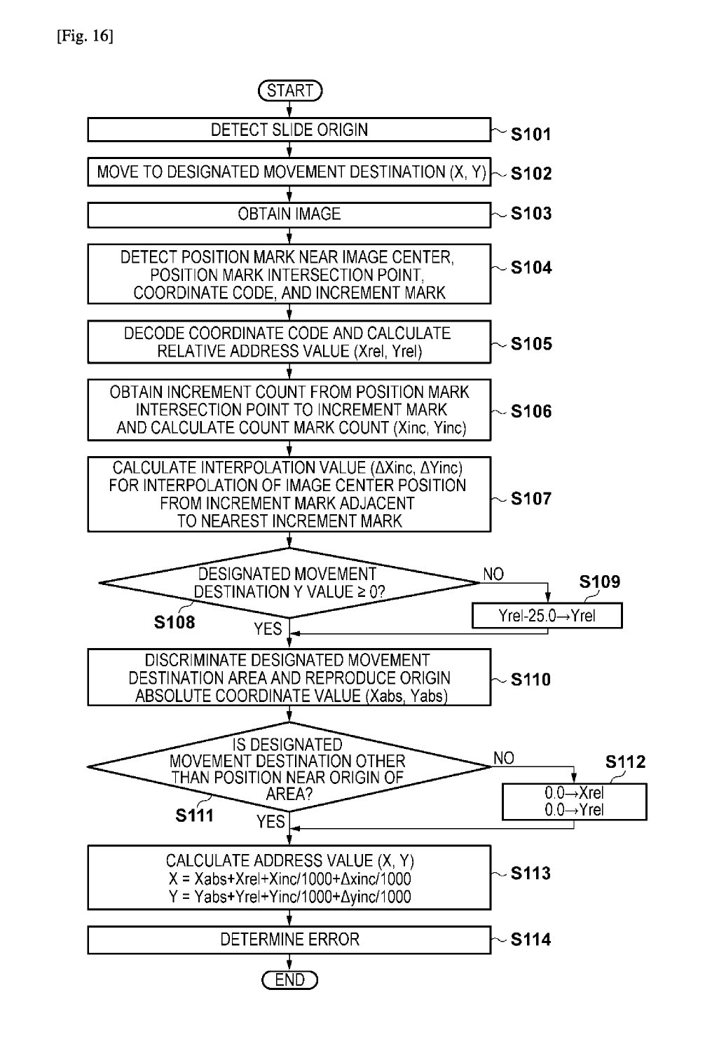

Address position checking (address reproduction) of the arrival point of the XYZ stage 55 when performing the above accuracy checking or the like will be described with reference to a flowchart. FIG. 16 shows a flowchart for address position checking of the arrival point of the stage. Assume that the XYZ stage 55 has already moved based on movement designation. Assume also that the positioning accuracy management performance of the XYZ stage 55 falls within errors of ±25 μm, and the nearest address area 21 is not located next to the sensor center when the XYZ stage 55 has moved to a movement destination.

In step S101, the CPU 1301 detects the slide origin 7 of the slide 1 from an image (microscope image) obtained by the digital camera 61. The CPU 1301 then moves the stage so as to match the center of the sensor of the digital camera with the detected slide origin 7. In step S102, the CPU 1301 instructs movement amounts in the X and Y directions and moves the stage. For example, the CPU 1301 moves the XYZ stage 55 to the movement destination (X, Y) designated based on the slide origin 7. In step S103, the CPU 1301 obtains an image from the digital camera 61. That is, the CPU 1301 obtains a microscope image of a slide for positioning accuracy management. With this processing, for example, an image (microscope image) like that shown in FIG. 15A is obtained, and the center of the image becomes the center 64 of the sensor 63 (the image sensor of the digital camera 61). In step S104, the CPU 1301 detects the position mark 31, the position mark intersection point 37, and the position coordinate code 32 in the address area 21 near the image center (FIG. 15C) and the increment mark 33 (FIGS. 15C and 15D).

In steps S105 to S113, the CPU 1301 obtains the coordinate value of a specific position in the microscope image, obtained in step S101 after the movement of the XYZ stage 55, based on the address area 21 and the increment mark 33 included in the microscope image. In this embodiment, the CPU 1301 obtains the coordinate value of the center of the microscope image (the sensor center of the digital camera 61). First of all, in step S105, the CPU 1301 decodes the X-Y coordinate position into (Xrel, Yrel) based on the coordinate code detected in step S104 in the manner described with reference to FIGS. 10A and 10B. In a very rare case, the address area nearest to the image center is an origin (absolute position address area). In general, however, such an address area is a relative position address area. In step S106, the CPU 1301 counts the numbers of increment marks 33 from the position mark intersection point 37 to the increment mark 33 nearest to the image center position (corresponding to the cross mark in FIG. 15D) to set (Xinc, Yinc). In the case shown in FIG. 15D, the numbers of increment marks 33 are 10 in both the X and Y directions, thus setting (10, 10).

Referring to FIG. 15D, the image center matches the increment mark 33. However, they sometimes do not match each other. In such as case, in step S107, the CPU 1301 obtains the position of the image center by interpolation in, for example, the following manner. As shown in FIG. 15E, the CPU 1301 extracts increment mark A, of the four increment marks 33 surrounding the center 64, which is nearest to the center 64, and increment marks B and C adjacent to increment mark A, and measures the distances between the increment marks and the image center on an image pixel basis. Letting (xa, ya) be the distance to increment mark A, (xb, yb) be the distance to increment mark B, (xc, yc) be the distance to increment mark C, and p be the pitch of the increment marks 33, distances (ΔXinc, ΔYinc) from the nearest increment mark 33 to the image center in the X and Y directions are expressed as follows. Note that in this embodiment, p=1 μm.

X direction: ΔXinc=−xa/(xa+xb)·p

Y direction: ΔYinc=−ya/(ya+yc)·p

Subsequently, in order to cope with a case in which the Y value is in a negative region as shown in FIGS. 6A and 6B and the like, the CPU 1301 determines in step S108 whether the Y value at a designated movement designation is 0 or more. If the Y value is in a negative region (the Y value is less than 0), the process advances to step S109, in which the CPU 1301 replaces Yrel calculated in step S103 with Yrel-25.0. If the Y value is 0 or more, the process advances to step S110 without going through step S109.

In step S110, the CPU 1301 determines whether the designated movement destination is located in either of the first area 501 to the fourth area 504. The following is the relationship between the designated destinations and the areas (since the address areas are provided for every 0.1 mm, effective numeral values are considered in increments of 0.1 mm):

3.0≤X≤27.9 and −1.0≤Y≤23.9: first area 501

3.0≤X≤27.9 and 24.0≤Y≤9.0: second area 502

28.0≤X≤2.0 and −1.0≤Y≤23.9: third area 503

28.0≤X≤52.0 and 24.0≤Y≤49.0: fourth area 504

Letting (Xabs, Yabs) be the absolute coordinates of the origin of an area to which a designated movement destination belongs, then

when the designated destination belongs to the first area 501, (Xabs, Yabs)=(3.0, 0.0),

when the designated destination belongs to the second area 502, (Xabs, Yabs)=(3.0, 24.0),

when the designated destination belongs to the third area 503, (Xabs, Yabs)=(28.0, 0.0), and

when the designated destination belongs to the fourth area 504, (Xabs, Yabs)=(28.0, 24.0).

Considering a case in which the designated movement destination is the origin of an area, the CPU 1301 determines in step S111 whether the designated movement destination is near the origin (within the absolute position address area). If the designated movement destination is near the origin, the CPU 1301 replaces (Xrel, Yrel) with (0.0, 0.0) in step S112. In step S113, the CPU 1301 calculates an address position (X, Y) of the image center. If the designated movement destination is not near the origin of the area, (Xrel, Yrel) obtained in step S102 is used without any change.

The calculation of the address position (X, Y) of the image center in step S113 will be described. In this embodiment, Xabs, Xrel, Yabs, and Yrel are in mm, and Xinc, Yinc, ΔXinc, and ΔYinc are in μm. Therefore, (X, Y) is calculated in the following manner, and it is possible in principle to check position coordinates at submicron level.

X=Xabs+Xrel+Xinc/1000+ΔXinc/1000

Y=Yabs+Yrel+Yinc/1000+ΔYinc/1000

In step S114, the CPU 1301 determines an error based on the actual movement amount of the XYZ stage 55 based on the coordinate value obtained in step S113 and the movement amount instructed in step S102. As described above, the determined error can be used for the correction of the movement amount of the XYZ stage 55 or for position management performance accuracy changing/evaluation of the XYZ stage 55. Note that in the above processing, after the center 64 of the sensor 63 of the digital camera 61 is matched with the slide origin 7, the coordinates of the central position of the XYZ stage 55 are obtained. However, this is not exhaustive. For example, the positon of the slide origin 7 in a microscope image may be set as a specific position in the image, and an actual movement amount may be obtained by obtaining the coordinates of the specific position in the image obtained after the movement of the XYZ stage 55 to the designated movement destination. That is, the actual movement of the stage is obtained based on the position of the slide origin detected in step S101 and the coordinate value of the specific position in the microscope image after the movement of the XYZ stage 55 (in this embodiment, the central position).

As described above, according to the first embodiment, the slide 1, which has an outer shape similar to that of a large slide, is provided with marks indicating coordinate axes and origins, position coordinate marks and their position coordinate codes based on the origins, and increment marks. This makes it possible to correct and check the position control performance of the stage in the cover glass area or the like at the time of construction of the microscope system and on the user's side such as the pathologist's side.

Note that the first embodiment has been described to facilitate the understanding of the present invention and not to limit the invention. Therefore, each element disclosed in the first embodiment includes all design changes and equivalents belonging to the technical scope of the present invention.

### Second Embodiment

The second embodiment will be described next. A slide according to the second embodiment is the same as the slide 1 according to the first embodiment in terms of outer appearance and material. Note however that drawn marks and layouts are different from those in the first embodiment.

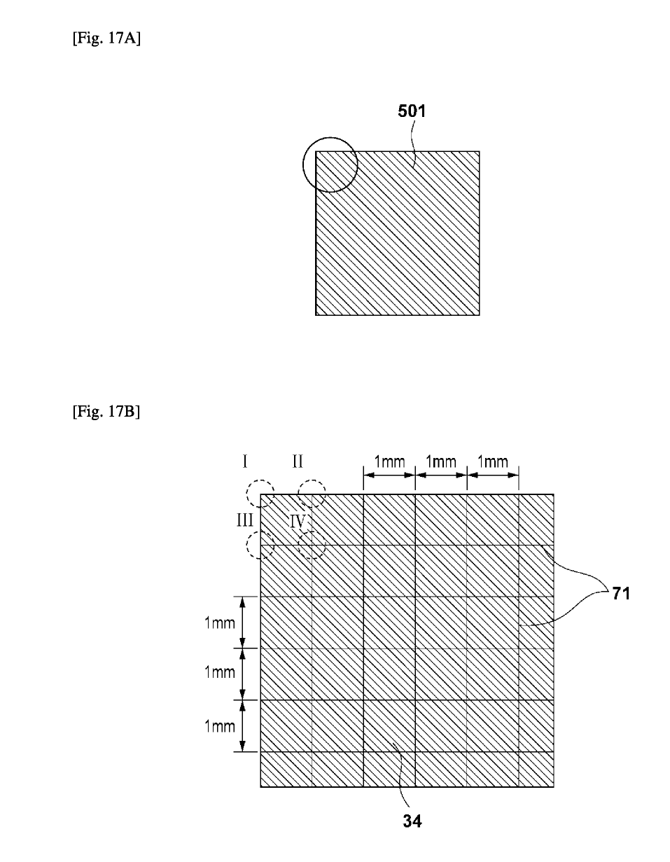

FIGS. 17A and 17B show a layout of the second embodiment which corresponds to the first area 501 in “5A” in FIG. 5 according to the first embodiment. FIG. 17A shows a first area 501. FIG. 17B is an enlarged view of the portion indicated by the circle in FIG. 17A. As shown in FIG. 17B, unlike in the first embodiment, a grid line 71 is added for every 1 mm. As described above, in the second embodiment, a grid line in the Y direction is added for every a predetermined number of address areas 21 arranged in the X direction, a grid line in the X direction is added for every a predetermined number of address areas arranged in the Y direction.

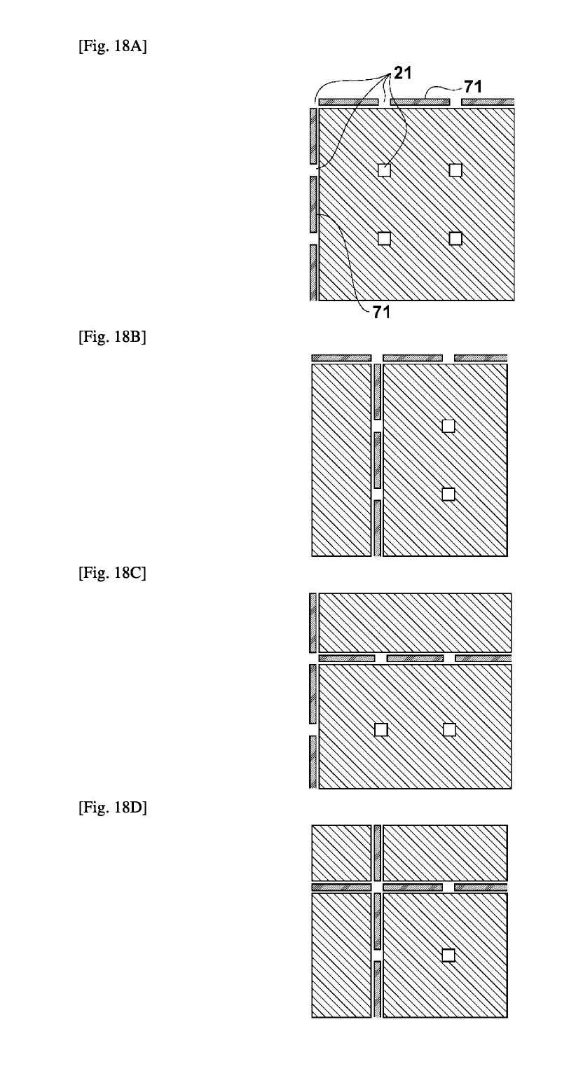

FIGS. 18A to 18D are respectively enlarged views of the portions indicated by dotted line circles (I), (II), (III), and (IV) in FIG. 17B. As shown in FIGS. 18A to 18D, the grid lines 71 are provided except for the address areas 21. The grid line 71 is provided for every 10 address areas 21, that is, every 1 mm, in each of the X and Y directions. Note that the position of the grid line 71 is a position indicating coordinates (XX.0, YY.0).

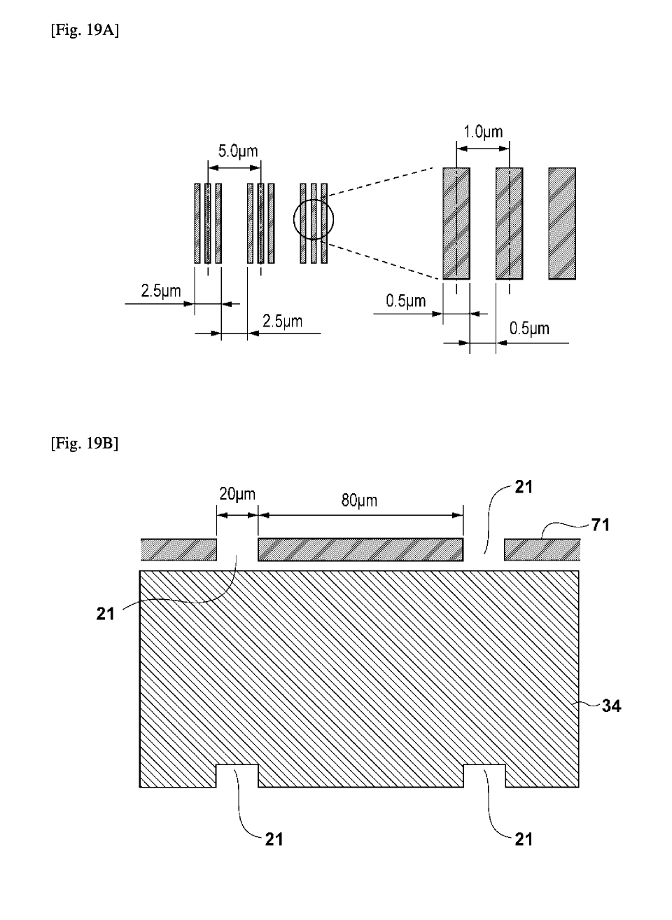

The grid line 71 also has a layout structure. This structure will be described in detail with reference to FIGS. 19A and 19B. As shown in FIG. 19A, a 2.5 μm wide line portion of the grid line 71 is constituted by three 0.5 μm wide lines and two 0.5 μm wide spaces like the central portion of the width layout of the Y-axis mark described in the first embodiment (FIG. 4). The grid line is constituted by three sets of 2.5 μm wide line portions and two 2.5 μm spaces between them.

FIG. 19B shows the relationship between the grid lines 71, the address areas 21 (white space portions), and part of an increment mark area 34. As shown in FIG. 19B, the grid line 71 has a dashed line structure constituted by a 80 μm long line and a 20 μm long space in the lengthwise direction (to be exact, a 80.5 μm long line and a 19.5 μm long space), with its space portion being assigned to the address area 21. That is, the grid line 71 is a dashed line having a space at a position where the address area 21 is arranged, and hence does not interfere with any mark in the address area 21.

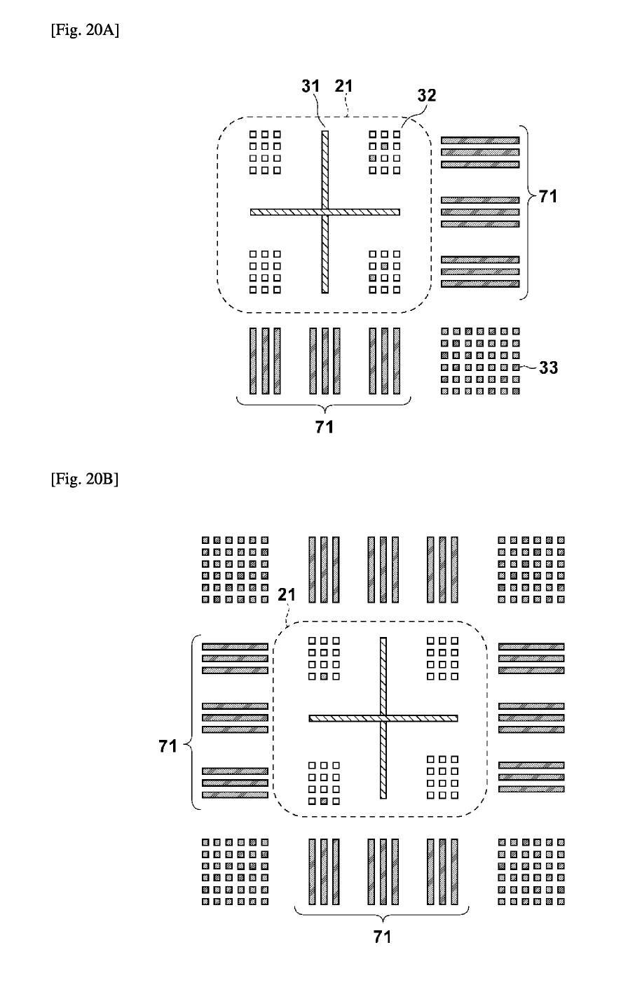

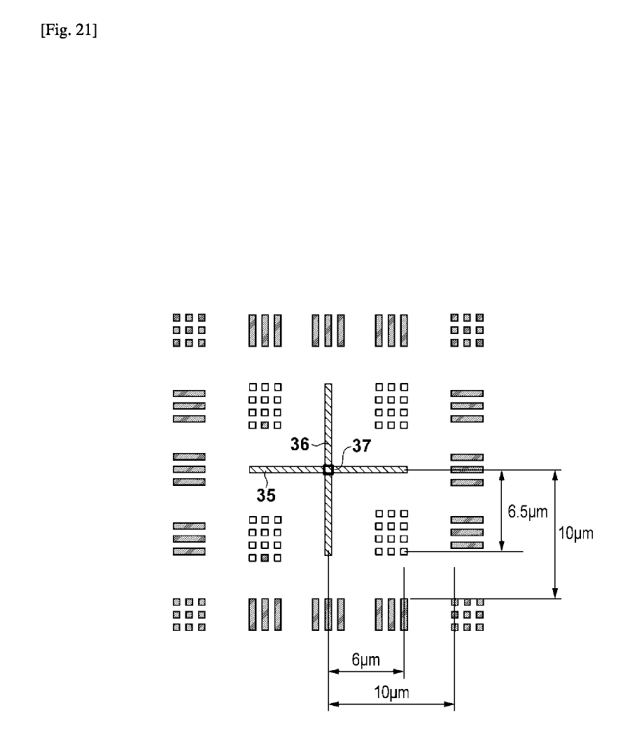

FIGS. 20A and 20B respectively show enlarged layouts of portions where the grid lines 71 in FIGS. 18A and 18D intersect. As described above, in the second embodiment, part of the portion shown in FIG. 7 or 8C in the first embodiment is replaced with the grid lines 71. In practice, as described above, the portion corresponding to the address (XX.0, YY.0) is replaced. In addition, a predetermined space is provided between the grid line 71 and the increment mark area 34. As indicated by the detailed layout in FIG. 21, the grid line 71 is spaced apart from the increment mark area 34 by 4 μm. In this manner, redundancy is ensured.

As described above, in the second embodiment, unlike the first embodiment, the grid line 71 is added for every 10 address areas 21 to emphasize addresses at 1 mm intervals. Therefore, the second embodiment can more facilitate position detection than the first embodiment. In addition, the grid line 71 is larger than the address area 21, and hence is resistant to dust, flaw, and the like. It is therefore possible to expect an improvement in redundancy of position detection.

As described above, since the slides for positioning accuracy management according to the first and second embodiments include marks indicating coordinate axes and origins, it is possible to match the coordinate system of each slide for positioning accuracy management with the absolute coordinate system based on the microscope. In addition, each slide includes position coordinate marks based on each origin and their position coordinate codes and increment marks, a position in the absolute coordinate system can be known at submicron level. This makes it possible to perform accurate evaluation in a position management area equivalent to the cover glass area at the time of the construction of a microscope system and on the user's side such as the pathologist's side.

In addition, since each positioning accuracy management area is divided into a plurality of areas, it is possible to use the same photomask by standardizing the relative position coordinates of the respective areas. This can provide an inexpensive slide for positioning accuracy management. Furthermore, providing a new mark for every a plurality of address mark areas can implement a slide for positioning accuracy management which is resistant to dust, flaw, and the like.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-169726, filed Aug. 28, 2015, which is hereby incorporated by reference herein in its entirety.

1. A slide for positioning accuracy management for a stage for a microscope, the slide comprising:
a first mark for specifying a position of a slide origin;
a plurality of position display areas arranged in matrix and each including a second mark indicating a position and a position coordinate code for specifying coordinates of the position based on the slide origin; and
a plurality of third marks arranged in matrix in an area other than the plurality of position display areas at intervals smaller than intervals of the position display areas.

2. The slide according to claim 1, wherein the plurality of position display areas and the plurality of third marks are arranged for each of a plurality of partial areas obtained by dividing a management area for positioning accuracy management.

3. The slide according to claim 2, wherein in each of the plurality of partial areas,
the position coordinate code in a position display area, of the plurality of position display areas, which indicates an origin position of a partial area indicates coordinates based on the slide origin, and
a position coordinate code of a position display area, of the plurality of position display areas, which is other than a position display area indicating the origin position indicates coordinates based on the origin position.

4. The slide according to claim 2, further comprising a label area and a cover glass area for arranging a sample and a cover glass,
wherein the management area is arranged in the cover glass area.

5. The slide according to claim 1, wherein the position coordinate code is arranged at a predetermined position relative to the second mark.

6. The slide according to claim 1, wherein the position coordinate code includes not less than two sets of patterns indicating the same coordinate value.

7. The slide according to claim 1, wherein the position display areas are arrayed at first predetermined intervals in an X direction and at second predetermined intervals in a Y direction.

8. The slide according to claim 7, wherein the first predetermined interval is equal to the second predetermined interval.

9. The slide according to claim 1, wherein a grid line in a Y direction is added for every a predetermined number of the position display areas arrayed in an X direction, and
a grid line in the X direction is added for every a predetermined number of the position display areas arrayed in the Y direction.

10. The slide according to claim 9, wherein the grid line comprises a dashed line having a space at a position where the position display area is arranged.

11. The slide according to claim 1, further comprising a label area and a cover glass area for arranging a sample and a cover glass,
wherein the first mark is arranged in a sandwiched area between the label area and the cover glass area.

12. The slide according to claim 11, wherein the label area and the cover glass area are arrayed in an X direction, and the sandwiched area extends in a Y direction, and
the first mark includes a first mark whose barycentric position in the X direction indicates an X-coordinate of the slide origin and a second mark whose barycentric position in the Y direction indicates a Y-coordinate of the slide origin.

13. The slide according to claim 12, wherein the first mark extends in the Y direction and defines a Y-axis direction.

14. A positioning accuracy management apparatus comprising:
an imaging unit, mounted on a stage, configured to obtain a microscope image of a slide for positioning accuracy management wherein the slide comprises: a first mark for specifying a position of a slide origin; a plurality of position display areas arranged in matrix and each including a second mark indicating a position and a position coordinate code for specifying coordinates of the position based on the slide origin; and a plurality of third marks arranged in matrix in an area other than the plurality of position display areas at intervals smaller than intervals of the position display areas;
a detection unit configured to detect a slide origin of the slide for positioning accuracy management from the microscope image obtained by the imaging unit;
a moving unit configured to move the stage upon instructing movement amounts in X and Y directions to the stage;
an obtaining unit configured to obtain a coordinate value at a specific position in a microscope image obtained by the imaging unit after movement of the stage by the moving unit based on a position display area and a third mark included in the microscope image; and
a determination unit configured to determine an error based on an actual movement amount of the stage obtained based on a position of the slide origin detected by the detection unit and a coordinate value of the specific position and the instructed movement amount.

15. A positioning accuracy management method using a slide for positioning accuracy management wherein the slide comprises: a first mark for specifying a position of a slide origin; a plurality of position display areas arranged in matrix and each including a second mark indicating a position and a position coordinate code for specifying coordinates of the position based on the slide origin; and a plurality of third marks arranged in matrix in an area other than the plurality of position display areas at intervals smaller than intervals of the position display areas, the method comprising:
detecting a slide origin of the slide for positioning accuracy management from a microscope image obtained by obtaining an image from a microscope for the slide for positioning accuracy management which is mounted on a stage;
moving the stage upon instructing movement amounts in X and Y directions to the stage;
obtaining a coordinate value at a specific position in a microscope image obtained by obtaining an image form the microscope after movement of the stage in the moving based on a position display area and a third mark included in the microscope image; and
determining an error based on an actual movement amount of the stage obtained based on a position of the slide origin detected in the detecting and a coordinate value of the specific position and the instructed movement amount.

16. A non-transitory computer readable storage medium storing a program for causing a computer to execute a positioning accuracy management method using a slide for positioning accuracy management wherein the slide comprises: a first mark for specifying a position of a slide origin; a plurality of position display areas arranged in matrix and each including a second mark indicating a position and a position coordinate code for specifying coordinates of the position based on the slide origin; and a plurality of third marks arranged in matrix in an area other than the plurality of position display areas at intervals smaller than intervals of the position display areas, the method comprising:
detecting a slide origin of the slide for positioning accuracy management from a microscope image obtained by obtaining an image from a microscope for the slide for positioning accuracy management which is mounted on a stage;
moving the stage upon instructing movement amounts in X and Y directions to the stage;
obtaining a coordinate value at a specific position in a microscope image obtained by obtaining an image form the microscope after movement of the stage in the moving based on a position display area and a third mark included in the microscope image; and
determining an error based on an actual movement amount of the stage obtained based on a position of the slide origin detected in the detecting and a coordinate value of the specific position and the instructed movement amount.
